(19) United States
(12) Patent Application Publication
(10) Pub. No.: US 2009/0138275 A1
(43) Pub. Date: May 28, 2009

(54) SYSTEM FOR PRODUCT AUTHENTICATION POWERED BY PHONE TRANSMISSION

(76) Inventor: BENJAMIN MAYTAL, Mevasseret Zion (IL)

Correspondence Address: DANIEL J SWIRSKY, 55 REUVEN ST., BEIT SHEMESH, 99544, IL

(21) Appl. No.: 12/276,473

(22) Filed: Nov. 24, 2008

Related U.S. Application Data
(63) Continuation of application No. 12/302,029.

(51) Int. Cl. G06Q 99/00

(52) U.S. Cl. 705/1

(57) ABSTRACT

An authentication system enabling a customer to verify the authenticity of a product in a foolproof, secure and simple manner plurality of secret sets of numbers is generated, each set comprising a challenge portion and a response portion. These sets are stored on a remote server. Each set is associated with a different product. The customer sends a challenge portion to the server, and prompts the server to provide a response. If the response matches that of the product in hand, the product is known to be authentic. In another embodiment of the system, cellular transmission is used to power an electronic tag attached to the product and carrying authentication data. In a third embodiment, the full manufacturer database is divided into separate databases, possibly related to product vendor, such that an authentication process can be performed without the need to access the manufacturer's entire database of products.

### FIELD OF THE INVENTION

The present invention relates to the field of product authentication, especially with regard to the determination whether a product bought by a customer is an authentic product or a fake, and with regard to secure methods of communication for product authentication and tracking.

### BACKGROUND OF THE INVENTION

Many companies suffer from counterfeit products produced by pirate manufacturers and their distributors. These fake products are manufactured to look like the authentic original products, but are in fact not so. Counterfeiting is a major problem in many market segments—pharmaceutical drugs, cosmetics, cigarettes, jewelry, clothing & shoes, auto parts. Tens of billions of dollars of counterfeited products are sold every year, resulting in huge losses to the manufacturers of the genuine products.

Currently, although a number of means are used to validate the authenticity of products, such methods are not always reliable or user friendly for the purchaser of the product. The most common method used currently for the authentication function, is by adding to the package a special component such as a Hologram, which is meant to be unique to the manufacturer.

The problems with this approach are:
a) The holograms themselves can be faked by the product pirates, such that they look like the original hologram.
b) Many consumers cannot tell the difference even if the fake hologram is somewhat different than the original one.
c) The cost of a hologram makes it unpractical for low-cost items such as cigarettes.

There is therefore a need for a simple and reliable method to allow the consumer to validate the authenticity of the product that he has purchased, whether in a shop, via mail delivery, over the internet, or otherwise.

The use of Radio Frequency Identity Tags (RFID tags) to prevent fakes and counterfeit products is growing, despite the fact that RFID has a number of disadvantages, such as:
(a) Cost is comparatively high, and RFID thus only makes sense for high value products.
(b) Most users do not have RFID readers, so they have no means to check the authenticity of the RFID and the product, in their homes or even at the point of purchase.
(c) Low-cost RFID chips can be produced, but such types are often insecure and can easily be cloned.

It is to be noted that although the term RFID is formally used for identity tags which RF communicate with the outside world by means of the IEEE 802.13 protocol, the term RFID is used in this application in its generic sense, to mean an identity tag which communicates its information by radio frequency, whether or not it strictly conforms with the conventional communication protocol, and the invention is not meant to be limited thereto.

There is therefore also a need for a simple and reliable method to allow the consumer to interrogate an electronic tag on a product, to validate the authenticity of the product that he has purchased, yet without the need for special RFID reading equipment.

If such access to an electronic tag could be enabled, the means of communication could then be used to tackle not only verification, but also other problems related to tracing and tracking of products. There exist in the prior art a number of such systems for dynamic product information exchange, such as U.S. Pat. No. 7,126,481, for “Methods, Systems, Devices and Computer Program Products for Providing Dynamic Product Information in Short Range Communication”, assigned to the Nokia Corporation, and other art cited therein. However, this method and system bases itself on the information stored on the tag, and utilized by means of applications based on a cellular phone having access to an outside server carrying supporting applications. No access to a full database of products is described. There therefore exists a need for an authentication, verification and tracking communication system which has access to a full database of products. Additionally, where such a full database of products is regarded as commercially sensitive data, there is need for a method of authentication using the database, but avoiding such a sensitive concentration of data.

The disclosures of each of the publications mentioned in this section and in other sections of the specification, are hereby incorporated by reference, each in its entirety.

### SUMMARY OF THE INVENTION

The present invention seeks to provide a new authentication system that overcomes some of the disadvantages of prior art systems, from a number of aspects. According to the various embodiments of the present invention, the system enables a customer to verify the authenticity of the product he has or is going to purchase, in a foolproof, secure and simple manner.

According to a first preferred embodiment, the system operates by associating with each product to be authenticated, a unique number set, comprising one or more character sequences. The number sets are generated by the product supplier and preferably stored at a remote central register of number sets, which can be tele-accessed by the customer. This number set can preferably be printed on the product or its packaging in a hidden manner, such as under a scratch-off layer. Alternatively and preferably, it can be included as a packing slip inside the product packaging. After purchase, the customer reveals the number set, and accesses the supplier's remote central register of number sets, where its presence can be used to authenticate the product as an original and not a fake. The remote checking system then returns the corresponding response to the customer. However, if the response is simply an affirmation or denial as to the authenticity of the product, in the form of a simple AUTHENTIC or FAKE response, depending on whether or not the character sequence sent by the customer exists in the central register as corresponding to a genuine number associated with an authentic product, it would be simple for the counterfeiters to include a bogus communication address with the product, contact with which always returns an AUTHENTIC verification answer.

Therefore, according to this first preferred embodiment of the present invention, the number set preferably comprises at least a pair of character sequences, one of which is a challenge sequence, which the customer sends to the supplier's remote central register of numbers, preferably stored on a remote server, and another is a response sequence, predetermined to be associated with that specific challenge sequence, and stored on the remote central register of numbers. The Remote Checking System then sends back the response sequence matching the challenge sequence. If the returned Response sequence matches the second sequence of the number set associated with the product in his hand, the customer knows with high level of probability that his product is authentic. If the response disagrees, the product is likely to be a fake. The Remote Checking System can also optionally apply checks to the Challenge—the most important one being that the response is only generated once—the first time that that particular Challenge is received, thus thwarting attempts to circumvent the system by the wholesale use of a single authentic number set on numerous counterfeit products.

According to this embodiment, the present invention thus generally comprises:
1. Secret sets of individual numbers, where each set may preferably be divided into a Challenge and one or more Responses.
2. Association of a single different one of these secret sets to each item which it is desired to protect.
3. A remote checking system where the number set associated with the product can be authenticated.

In a typical case, one (or more) secret sets are associated with a product preferably either by covert printing on the packaging or by placing inside the packaging. The secret set should preferably be accessible for viewing by the end user only after the purchasing is done, and by affecting the packaging or some element of it. Once the consumer has purchased the product and wishes to authenticate it, he exposes the secret set (e.g. by scratching off the layer used to render the printing unobservable, or by opening the product package) and sends the Challenge part of the secret set to the Remote Checking System. The Remote Checking System then applies some checks on the Challenge—the most important one being to ascertain that this is the first time that this particular challenge has been presented. This check is essential to ensure that each number set is used only once, to ensure that persons using stolen or used secret numbers cannot achieve repeated access to the system with a single number set. If the checks are correctly passed, the Remote Checking System then sends back the correct response associated with that Challenge, and disenables or deletes the set from its storage, to ensure that the set is not used a second time by secret number thieves. The consumer then compares the response received with the Respond numbers on his packaging and if they match, he knows with high level of probability that he has purchased an original product.

This preferred embodiment is generally useful for application to real, physical products such as medicines, food, cloths, toys, luxury items, etc., but cannot be used in a simple manner on ‘digital’ products such as files of content or software utilities, which could be doctored to generate their own, always-correct responses.

According to a second preferred embodiment of the present invention, an electronic tag is used for identifying the product being checked. In order to provide the communication link between the tag and the manufacturer's central register of numbers without the need for a dedicated RFID reader, the product is verified using a regular cellular phone. Attached to the product is a secure electronic tag having a secure signature and encryption scheme. The system differs from those of the prior art, in which the tag is powered by means of charging generated from its own short-range communication channel, in that in this invention, the comparatively strong cellular phone transmission signal is used to charge the tag. The tag then broadcasts its information in one of the standard cellular phone short range communication methods, such as Bluetooth, NFC, IR, or similar. The cellular phone transmits the information to a server, which can either have full duplex communication with the tag or it can perform the authentication itself. This method thus enables the powering of a communication device by means of the transmission from a different communication channel. According to further preferred embodiments, the strong cellular transmission can be used to power more than one short range communication channel, each having its own antenna for picking up the cellular transmission, such as Bluetooth and a conventional RFID channel.

Besides its use for the communication of authentication data, this embodiment of the present invention can also be used for general purpose communication of product data. It is a method for enabling a short range communication device, such as Bluetooth (BT), to communicate with a cellular handset by utilizing the cellular long range transmission signal to produce power for the device operation.

According to a third preferred embodiment of the present invention, there is provided a novel vendor tag verification system, in which electronic tags attached to the end user product, are used for track and trace purposes and for authentication anti-counterfeiting purposes, using a cellular telephone having the ability to enable the validation act. The phone communicates the tag ID information to an external server containing a database with details of all of the tagged products, and handles the transfer and display of any information returned from the server to the user. According to this embodiment, for the verification aspects, the user's activation of the validation application causes the server to send a challenge through the user's phone to the tag, which responds through the phone to the server, which in turn decides whether the response is correct or not, and returns a response to the enquirer. For the tracking aspects, the server generally stores the response received from the tag as part of the database of the location and details of products, which can then be re-accessed for providing information about the location or details of any particular product. According to a further preferred embodiment, the cellular phone can provide to the server its physical location, which is generally close to the product being verified, such that the server can use this information to update a stock list of the actual location of products being tracked.

Tracking/verification systems of this kind generally involve access to a complete manufacturer or prime-vendor database of all of the products sold for the whole of the lifetime of the product line. Such a database will generally contain commercially sensitive product volume and status data, such as the total number of products sold, the number of products rejected, the serial numbers of products whose expiry date has been reached, the number of products stolen, and the like. The manufacturer or vendors may not wish such data to be accessible in any manner from outside their own in-house data base, such that use of an externally accessible database with this information may not be advisable.

According to a further preferred embodiment of the present invention, a tracking/verification system is provided in which the tracking/verification process involves initial access to a main server which, unlike the previous embodiment, does not have the entire product database, and therefore cannot give the verification response itself. Instead, the main server contains only information as to where the data relating to that particular product is kept on a satellite or secondary server. Thus for instance, on receipt of a product number query, the main server sends out a response, preferably encrypted, which contains a secondary server location ID associated with that product number, and access is provided just to the data on that secondary server. If each secondary server is associated, for instance, with a specific vendor of those products, then each enquiry for authentication or tracking of a particular product is directed to the server of the vendor who supplied the particular product queried. Each vendor database could only contain a fraction of the total product database, such that the commercial secrecy of the total product database is maintained. The main server accessed does not need to contain any relevant data about the product queried, other than a preferably encrypted database of vendors, which provides the identity of the secondary server associated with the vendor of that particular product. That secondary vendor database then decides what limited information will be presented back to the end user or to the store making the enquiry, and returns the information for display on the enquirer's cellular telephone. This embodiment has been described with the product information being situated on a series of vendor servers, since this is a logical location for that information. However, it is to be understood that the invention is not meant to be limited to information being maintained on vendor servers, but that any remote collection of servers can equally well be used in order to disperse and thus to protect the integrity of the complete product database.

Alternatively and preferably, the server location information for each product could be contained in the ID carried by the electronic tag, which would then have two parts, an ID for the product itself, and an ID for the identity or location of the secondary server on which that product data is kept. According to this embodiment, the main server does not keep data relating to the secondary server associated with any product ID, since this is provided by the electronic tag itself. Instead, the main server operates as a routing server, directing the preferably encrypted product server information to the appropriate secondary server. In order to enable the secondary server information on the tag to be amended if necessary, such as when stock is moved, or is handled by a different vendor, according to this embodiment, the secondary server ID or location is preferably carried on the tag in a rewritable or flash memory.

The system of this fourth preferred embodiment can be used for track and trace applications, such that the organization logistics team can determine the exact size, location and status of any item of the stock, spread over numerous locations, yet without compromising the sum total of the organization's stock situation on any one central server.

The system according to this fourth preferred embodiment is described generally in this application as suitable for use with methods of interrogation of electronic tags using cellular telephones, whereby the phone sends the tag information to the main server, which simply passes it on to the secondary vendor server after determining which vendor server contains the particular information requested. However, it is to be understood that the method is equally applicable, at least for verification use, to systems where the product information is not contained on an electronic tag, but rather on a packet enclosure, or a covertly printed serial number, as described for the first embodiment of the present invention.

In general, the activation of the authentication process can be executed by any suitable method, whether by key strokes on the cellular phone that activate a routine on the phone, or by the consumer calling a number that reaches a response center, or by sending an SMS to a response center, by sending an Instant Message to a response center, or by any similar method of communication available. Furthermore, the data flow itself can be initiated either by the tag, meaning that the handset asks the tag for a verification code and then sends it to the server; or by the cellular phone handset, meaning that the handset generates a “Challenge”; or by the server, meaning that the handset first asks the server for a “Challenge”, and then sends it to the tag.

There is thus provided in accordance with a preferred embodiment of the present invention, a system for authenticating a product selected from a group of products, the system comprising:
(i) a tag associated with the product, the tag containing information relating to the identity of the product,
(ii) a plurality of secondary servers, each containing a database of information relating to a different part of the total group of products, and
(iii) a database carried on a central server, the database comprising data regarding the identity of the secondary server which contains information relating to at least some of the products of the group,
   wherein the information on the tag is transferred to the central server, which, on the basis of its database, transfers the information to the appropriate secondary server for activating authentication of the product.

In the above described system, the database on the central server preferably associates the secondary server identity of the product with the information relating to the identity of the product. Additionally, the database on each of the secondary servers may contain information relating to a common commercial aspect of the part of the total group of products contained on that database, and the common commercial aspect may preferably be the vendor of all of the products in that part of the total group of products.

The information relating to essentially all of the products of the group is preferably all contained on one of the secondary servers, but no single server should contain a database of information relating to the entire group of the products.

There is further provided in accordance with yet another preferred embodiment of the present invention a system as described above, and wherein the information on the tag is transferred to and from the central server through a cellular phone.

In accordance with still another preferred embodiment of the present invention, the secondary server preferably either activates authentication of the product by checking information regarding the product on its database, and confirming or denying authenticity based on the information, or it activates authentication of the product by checking information regarding the product on its database, and sending a challenge back to the tag on the product, such that the product tag can respond to the challenge. In the latter case, the secondary server preferably may determine the authenticity of the product according to the response received back from the product tag. In any of these cases, the tag may preferably either be an electronic tag, and the response is generated electronically by the tag, or it may be a physically visible tag, and the response is generated by a user reading the information on the tag. In the latter case, the information on the tag is preferably inaccessible to the user until the product is in the possession of the user, such as by virtue of covert printing.

There is further provided in accordance with still another preferred embodiment of the present invention, a system for authenticating a product selected from a group of products, the system comprising:
(i) a tag associated with the product, the tag containing information relating to the identity of the product and to the identity of a secondary server on which additional information regarding the product is contained,
(ii) a plurality of secondary servers, each containing a database of information relating to a different part of the total group of products, and
(iii) a central server, receiving the product identity information and the secondary server identity information, and routing at least the product identity information to the appropriate secondary server, wherein the appropriate secondary server utilizes the information on its database for activating authentication of the product.

In such a system, the appropriate secondary server preferably either activates authentication of the product by checking information regarding the product on its database, and confirming or denying authenticity based on the information, or it activates authentication of the product by checking information regarding the product on its database, and sending a challenge back to the tag on the product, such that the product tag can respond to the challenge. In the latter case, the secondary server may determine the authenticity of the product according to the response received back from the product tag. In any of these cases, the information on the tag is preferably transferred to and from the central server through a cellular phone. Furthermore, the information transferred between the product tag and at least the central server may preferably be encrypted.

In accordance with a further preferred embodiment of the present invention, there is also provided a method for determining the authenticity of an item comprising:
(i) generating a plurality of secret sets of individual character sequences, each secret set comprising a challenge and a response, and associating a different one of these secret sets to each item,
(ii) storage of the secret sets on a checking system, such that input of a challenge to the system generates the return of the response connected with the challenge,
(iii) sending to the checking system, the challenge part of a secret set associated with the item whose authenticity it is desired to determine, and
(iv) comparing the response returned from the checking system with the response associated with the item.

According to this method, the response preferably comprises at least one sequence of characters, and may preferably comprise more than one sequence of characters, each sequence having its own label, and the challenge then preferably includes a request for the sequence of characters in the response associated with a selected label.

In any of these methods, the checking system is preferably adapted to send back the response associated with a secret set only once.

In accordance with yet a further preferred embodiment of the present invention, in any of the above-mentioned methods, the secret set is preferably associated with the item by any one of printing, embossing, engraving, imprinting and stamping on any one of the item itself, the packaging of the item, an insert within the packaging of the item, and a label attached to the item. The secret set should preferably not be visually accessible to a customer until the customer has physical access to the item. Preferably, the secret set may be covered by an opaque scratch-off layer.

In accordance with still another preferred embodiment of the present invention, the secret set is associated with the item in such a manner that evidence is left after visual access to the secret set has been achieved. Finally, in any of the above-described methods, the challenge part may be sent to the checking system by any one of a phone, a computer connected to the Internet, a set-top box, and a bar-code reader connected to a network.

There is further provided in accordance with yet another preferred embodiment of the present invention, a system for determining the authenticity of an item comprising:
(i) a secret number set comprising a challenge and a response, the secret number set being attached to the item in a manner such that the secret number set can be viewed only after the item has been purchased,
(ii) a first entity that possesses the secret number set and wishes to determine the authenticity of the item, and
(iii) a second entity that has knowledge of the secret number set, wherein the first entity sends only the challenge to the second entity, the second entity, based on the challenge, uses the secret number set to send a response back to the first entity, and the first entity checks if the response sent is identical to the response known to the first entity.

In the above-mentioned system, the response preferably comprises at least one sequence of characters, and may preferably comprise more than one sequence of characters, each sequence having its own label, and the challenge then preferably includes a request for the sequence of characters in the response associated with a selected label.

In either of these systems, the checking system is preferably adapted to send back the response associated with a secret set only once.

In accordance with yet a further preferred embodiment of the present invention, in any of the above-mentioned systems, the first entity is a purchaser of the item, and the secret set is preferably associated with the item by any one of printing, embossing, engraving, imprinting and stamping on any one of the item itself, the packaging of the item, an insert within the packaging of the item, and a label attached to the item. The secret set should preferably not be visually accessible to a purchaser of the item until the purchaser has physical access to the item. Preferably, the secret set may be covered by an opaque scratch-off layer.

In accordance with still another preferred embodiment of the present invention, the secret set is associated with the item in such a manner that evidence is left after visual access to the secret set has been achieved. Finally, in any of the above-described systems, the first entity preferably sends the challenge to the second entity by any one of a phone, a computer connected to the Internet, a set-top box, and a bar-code reader connected to a network. Finally, in such a system, the second entity may preferably be a remote server which contains a plurality of secret number sets, each secret number set being associated with a different predetermined item.

In accordance with still another preferred embodiment of the present invention, there is further provided a system for enabling short range communication between an electronic device and a cellular phone, comprising:
(i) an antenna on the device adapted to receive cellular transmission from the phone, and
(ii) a short range communication channel, other than the cellular transmission, between the electronic device and the phone,
   wherein the electronic device is powered by the cellular transmission received through the antenna.

According to various preferred embodiments of the present invention, the short range communication channel may be any one of a Bluetooth link, Radio Frequency Identification (RFID) channel, Near Field Communication (NFC), an Infra-red optical link, and a WiFi, WiMax or WiBree network. The electronic device may preferably be a tag containing information relating to the authenticity of an item, and the information is transmitted to the phone over the short range communication channel. Alternatively and preferably, the electronic device may be any one of an earphone, a microphone, and a headset.

In accordance with still more preferred embodiments of the present invention, in this system, the electronic device may comprise a processing circuit and a short range communication device, both of which are powered by the cellular transmission received through the antenna. The device may further comprise a separate Radio Frequency Identification RFID channel having its own RFID antenna, such that the device is also able to be powered and communicate by RFID transmission. In the latter case, the device may be a dual mode tag containing information relating to the authenticity of an item. In all of these last mentioned systems including a short range communication channel, the communication between the phone and the electronic device may preferably be executed using a communication application activated by the phone user.

In accordance with a further preferred embodiment of the present invention, there is also provided a system for enabling short range communication between an electronic device and a cellular phone operating on a first communication channel, the system comprising:
(i) an antenna on the device adapted to receive cellular transmission from the phone on the first communication channel, and
(ii) a second, short range communication channel between the electronic device and the phone,
   wherein the electronic device is powered by reception of transmission through the antenna from a source other than its own communication channel. In this system, the communication between the phone and the electronic device is preferably executed using a communication application activated by the phone user.

There is also provided, in accordance with yet a further preferred embodiment of the present invention, a system for determining the authenticity of an item, comprising:
(i) an electronic tag containing information relating to the item,
(ii) a cellular phone providing cellular transmission, the phone being adapted to communicate with the tag over a short range communication channel other than the cellular transmission, and
(iii) an antenna tuned to receive the cellular transmission,
   wherein the electronic tag is powered by the cellular transmission received through the antenna. In this system, the communication between the phone and the electronic device is preferably executed using a communication application activated by the phone user.

There is even further provided in accordance with a preferred embodiment of the present invention a system for determining the authenticity of a product selected from a group of products, the system comprising:
(i) a product tag containing information relating to the identity of the product,
(ii) a database carried on a server containing details on at least some of the products in the group, and
(iii) a cellular telephone programmed to communicate data between the tag and the server,
   wherein the phone transfers the information on the tag to the server, which confirms to the phone the authenticity of the product according to the details of the product on the database.

In this system, the “at least some of the products in the group” may preferably comprise essentially all of the products in the group. The data communicated between the tag and the server through the phone may preferably be encrypted, and the data may preferably be communicated between the tag and the phone through a short range communication channel. In the latter case, the short range communication channel may be any one of a Bluetooth link, Radio Frequency Identification (RFID) channel, Near Field Communication (NFC), an Infra-red optical link, and a WiFi, WiMax or WiBree network. On the other hand, the data between the phone and the server is preferably communicated through a cellular phone network, which could operate as either one of GPRS and 3G service. Finally, the information relating to the product authenticity may preferably be displayed on the screen of the cellular phone.

Furthermore, in accordance with yet another preferred embodiment of the present invention, there is provided a system for determining the authenticity of a product selected from a group of products provided by a product supplier, the system comprising:
(i) a product tag containing information relating to the identity of the product,
(ii) a database carried on a remote server containing details on at least some of the products in the group, and
(iii) a cellular telephone programmed to communicate data between the tag and the server,
   wherein the phone transfers the identity information on the tag to the server, which invokes a bidirectional interrogation session with the tag through the phone, the response of the tag being used by the server to verify the authenticity of the product.

In this system, the server is preferably adapted to send a challenge via the phone to the tag, such that the tag can respond to the challenge on the basis of a predetermined response associated with the tag, the response being used by the server to determine the authenticity of the product. In such a case, the predetermined response can preferably either be contained on a visible record associated with the tag, such that the user can read the response from the record and return the response to the server through the phone, or it can be generated according to preprogrammed criteria by a logic program associated with the tag, and the generated response transferred to the server through the phone.

In this system, the “at least some of the products in the group” may preferably comprise essentially all of the products in the group. The data communicated between the tag and the server through the phone may preferably be encrypted, and the data may preferably be communicated between the tag and the phone through a short range communication channel. In the latter case, the short range communication channel may be any one of a Bluetooth link, Radio Frequency Identification (RFID) channel, Near Field Communication (NFC), an Infra-red optical link, and a WiFi, WiMax or WiBree network. On the other hand, the data between the phone and the server is preferably communicated through a cellular phone network, which could operate as either one of GPRS and 3G service. Finally, the information relating to the product authenticity may preferably be displayed on the screen of the cellular phone.

The various embodiments of the present invention have generally been described in this application in relation to authentication use, such as for anti-counterfeiting purposes. However, it is to be understood that the same systems and methods are equally applicable for use in track-and-trace applications, and the invention as described and claimed, is not intended to be limited to either one or the other.

### BRIEF DESCRIPTION OF THE DRAWINGS

The present invention will be understood and appreciated more fully from the following detailed description, taken in conjunction with the drawings in which:

FIG. 1 is a schematic view of a Secret Set generation system and procedure for use in product authentication, according to a first preferred embodiment of the present invention;

FIG. 2 is a schematic view of a system and procedure for attaching a secret set generated by the system of FIG. 1, to a product;

FIG. 3 is a schematic view of the steps of a product authentication process, using the secret sets shown in FIGS. 1 and 2;

FIG. 4 is a schematic view of a secure tag, according to a further preferred embodiment of the present invention;

FIG. 5 illustrates schematically a tag used for the execution of product authentication according to a further preferred embodiment of the present invention, using a cellular phone transmission for powering the tag;

FIG. 6 illustrates schematically a method by means of which the tag of FIG. 5 communicates with the external authentication system;

FIG. 7 is a schematic view of a further preferred embodiment of the present invention, whereby a dual mode tag serves both as an electronic tag and as a cellular communication tag;

FIG. 8 is a schematic view of a tag which communicates with the cellular phone using infrared (IR) signals;

FIG. 9 illustrates schematically a tracking/verification system constructed and operative according to a further preferred embodiment of the present invention;

FIG. 10 illustrates schematically a tracking/verification system constructed and operative according to a further preferred embodiment of the present invention; similar to that of FIG. 9 but with the additional use of secondary (vendor) servers; and

FIGS. 11, 12 and 13 are schematic flow charts of alternative and preferred methods of performing the verification process using the systems of FIGS. 9 and 10, from the product tag to the decryption server via the phone terminal.

### DETAILED DESCRIPTION OF THE INVENTION

Though the first preferred embodiment of this invention can be executed in its simplest form using a simple single string of digits and/or letters as the secret number set, there are a number of reasons for preferred use of a more complex secret number format, as will be used below in this detailed description of preferred embodiments of the invention, where a multiple selection response number system is described. Firstly, a more complex set decreases the likelihood of unauthorized access to the system using forged or stolen number sets. In addition, the preferred embodiment described involves the purchaser's active participation in the validation process, thus increasing customer confidence in the system Thirdly, using multiple sets of response numbers, it is possible to repeat each query for a specific product that number of times for additional safety, on condition that the checking system has been programmed to allow such multiple challenge. Finally, in the event that one of the response numbers becomes known, only part of the secret number is compromised, and the set can still be used as further verification.

However, it is to be understood that the invention is equally operable with simpler number sets which require simpler validation responses, as explained hereinabove in the Summary Section of this application.

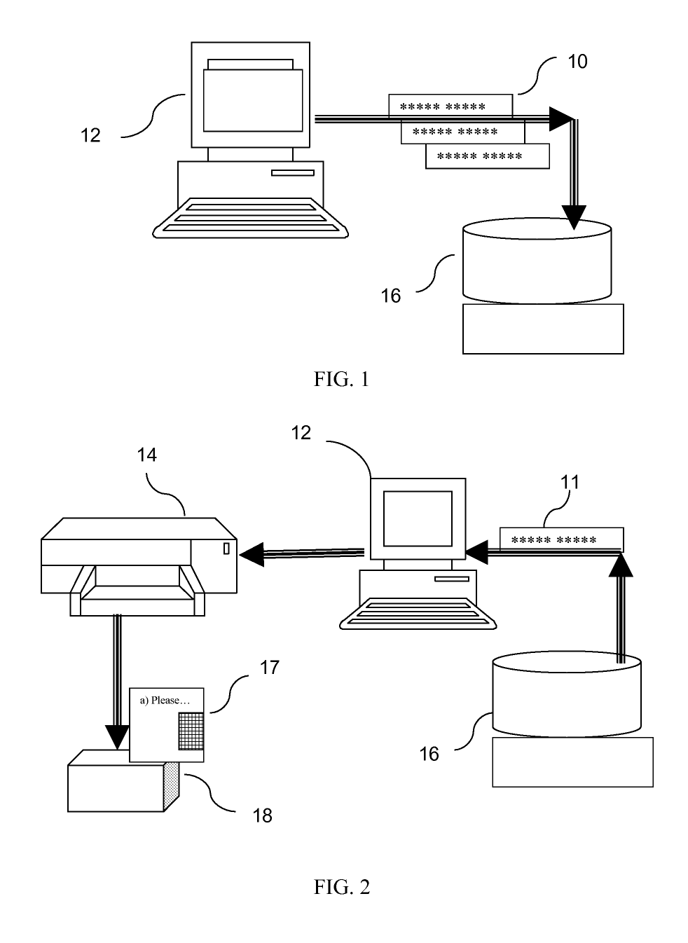

Reference is now made to FIGS. 1 to 4, which illustrate the use of a first preferred embodiment of the present invention, showing a “Challenge and Response” authentication system and its parts, and preferably comprising at least some of the following components:
(1) A Secret Set, 10, that has the form of {C, R[n]}, where:
C, “the Challenge”, is a string of digits & letters, preferably between 6 and 8 characters, and
R, “the Response” is a vector of n numbers, where n is typically 4, and each number has a few digits, preferably from 4 to 6 digits.
It is to be understood that these numbers of digits and characters are chosen for ease of use, combined with a sufficient number of unique sets, but that the invention is not meant to be limited by these particular examples.
(2) A Security Server 12, that can produce millions of Secret Sets, 10, either by means of a generating function or by creating a predetermined database of such sets
(3) A Response Server 10, that, on receipt of C and a user selected number i, which may typically be 1 to 4, preferably performs some checks on the past use of that particular C, and then responds with R[i].
(4) An associating device that attaches one or more of the Secret Sets to the end product. Typically it is a Printing Device or a mounting device 14 that prints or mounts the Secret Set on the given product or on its packaging, and then masks it with an easily removable opaque material, such as that used in scratch-off lottery cards, so that only after the consumer scratches off the covering layer does the secret set become visible. According to an alternative and preferred embodiment, the secret-set is printed on the inside of the packaging, or contained on a package insert, or on the product itself, such that only after opening the packaging, can the consumer view the set.
(5) A Call-back utility 15, which is a utility that is used to provide access to the Response server 13 to check the authenticity of the product. It can be a phone, a PC connected to the net, a set top box that is connected to a call-back server, a barcode reader network connected to the Response Server, or any other dedicated device for these purposes.
(6) A Secret Database 16 for storage of the Secret Sets 10 produced in step (2); and
(7) A Tag 17 printed on the final product 18 to be authenticated, or included within or on the packaging of the final product.

There are preferably three phases to the authentication process:

### (i) Creation of Secret Sets (FIG. 1.)

Referring now to FIG. 1, the Security Server, 12, which is typically a strong PC generating large numbers of Secret Sets, 10. A secret set may preferably take the form of a challenge number, and a response set, for instance:
   {as13rt, {4357, 3489, 1245, 6538}}
where as13rt is the Challenge, namely the string that the user sends to the Response Server 13. In addition to this string the user preferably sends a number K, preferably from 1 to 4, which will be used by the Response Server to decide which answer to send back to the user
In the preferred example shown in FIG. 4, {4357, 3489, 1245, 6538} is the Response. These are the four potential answers that the user will get back from the Response Server 13. The exact answer received will depend on the value of K entered by the user.

There are two general methods for deriving the Responses to each Challenge:

(a) A Secure Database 16. In this method all the numbers are pre-generated randomly, and are stored in a huge database, 16

(b) A one-way function. In this method, only the Challenge is random and the Responses are calculated by cryptographic means. One preferred method is to have a Secret S, and to perform a one-way function such as MD5 on C & S. In other words R=F (C,S), where F is a strong, known, one-way function. The advantages of this method are that there is no need to store huge databases, and any secure device that knows the secret S, can calculate the required response. The disadvantage is that this method is based on the secrecy of S, and if by some means, S becomes compromised, the production of Secret Sets, or the provision of the correct responses to a challenge then becomes public knowledge, and hence worthless.

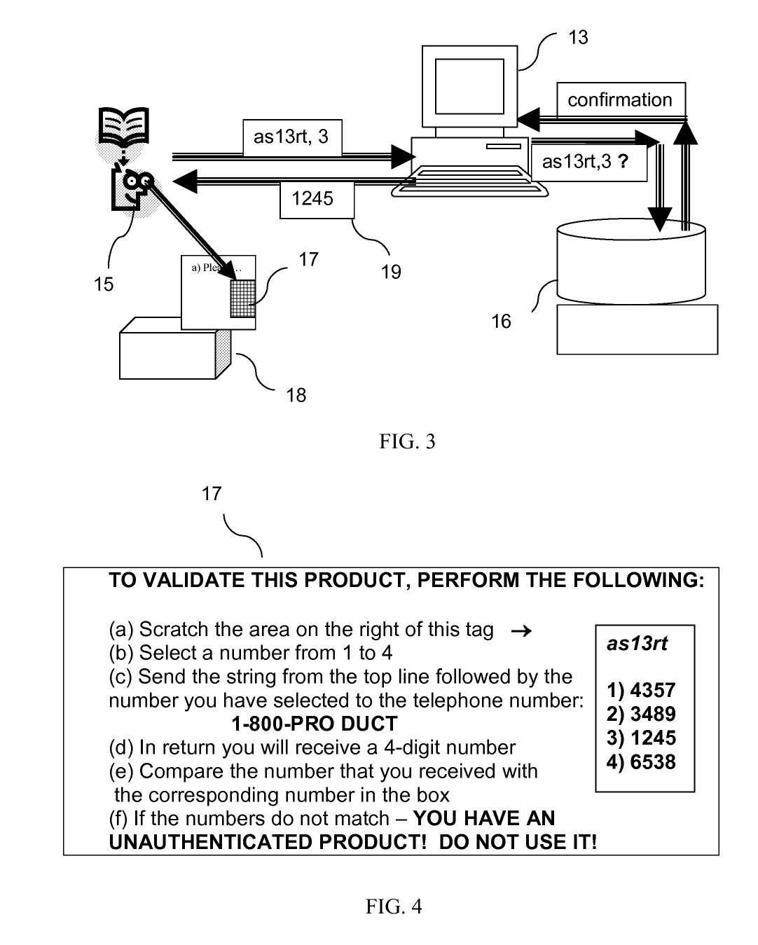

It is possible that in certain systems, both methods for deriving the Responses are used, whereby for sites with a high security rating, use is made of a database of secret numbers, while for sites with a lower security rating, the self-generated response method is sufficient.
At the end of the process the Security Server 12, will have listed all the Secret Sets 10 in a Secret Database 16.
   (ii) Associating Secret Sets with the End-Product (FIG. 2)
(a) The Mounting Machine 14, selects an unused set 11 of secret numbers from the Secret Database 16, and marks it off in the Database as used, together with some product related information, such as the date, location, type of product, etc.
(b) The Mounting Machine then preferably prints the selected set onto the packaging, or somewhere on the product itself 18, or on an insert for inclusion within the product package, together with some additional user instructions as to how to perform the authentication process. This could preferably be in the form of a tag 17. Reference is made to FIG. 4 which shows how a typical tag could look. The shaded area on the right of the tag is the covert area, which has to be scratched by the user to reveal the data beneath.
(c) According to the preferred embodiment using a package insert, the Mounting Device 14 simply prints the Secret Set inside the packaging, either directly, such as on the inner side of a cigarette box, or on a separate slip of paper that is inserted into the box. This embodiment obviates the need for the covert and scratch process. The disadvantage of this method is that the user needs to open the package in order to authenticate the product.
(iii) Consumer authentication of the Product (FIG. 3)

Reference is now made to FIG. 3, which illustrates schematically a preferred procedure by which the consumer 15, having purchased the product and wishing to authenticate it, follows the instructions on the tag and sends the challenge, C, preferably with the user selected number from the tag (as13rt,3 in the example used herewithin) to the response server 13 by means of a utility method.
The user 15 can preferably use one of several ways for contacting the Response Server:
(a) An Interactive Voice Response (IVR) based phone system, where the user inserts the Challenge using the keypad
(b) Phone system using Speech Recognition, so that the user can simply say the challenge
(c) An SMS system
(d) Use of the Internet from a PC or other device
(e) A Set-top Box, whereby the user inserts the Challenge and number select information via Remote
(f) Dedicated terminals, similar to barcode readers, with keypads and displays, located at the point of sale of the product.

The Response Server 13 looks for the value C in the Secret Set Database 16, and preferably performs one or more of the following checks:

Is the challenge in the database? Does it make sense to accept such a challenge? For instance, if the product undergoing authentication was intended, according to the manufacturer's or distributor's records, to be sold in a specific region, and the request comes from another region, or if the product has already expired—the Server can notify the relevant systems about the anomaly, and refuse to supply the response. This is done to protect against an attacker, who, by sending random numbers to the system, causes it to deny service to bona fide consumers, since those transmitted numbers will be signaled as ‘used’.

Is this the first time this number is being used? The Response Server 13 will preferably answer only once per challenge. This is done to ensure that used tags cannot be reused. If the tag being questioned had been ‘used’, the server preferably notifies the consumer about the possibility that this product is not original.

The server then preferably writes in the database that this Challenge has been requested together with the specific selected index number. It can also write at this stage other information, such as the date, time, geographical origin of the challenge, etc.

If the consumer is entitled to receive it, the server than preferably sends the correct response 19 back to the consumer preferably via one of the methods that the consumer used to send the Challenge.

According to further preferred embodiments of the present invention, the system can also be designed to operate where the Response vector comprises only a single number. The Secret Set thus comprises only two numbers C and R. Such an embodiment is simpler to use but does not incorporate the conceptual step by which the user is actively operative in determining which of several responses he will be receiving from the response server. Such active participation by the customer also decreases the danger that pirates may set up their own response site and server, to service their own cloned product tags. In such an operation, the pirates may intercept a customer Challenge call and use the single Response intercepted, out of the set of 4 Responses possible, but this will severely limit the customer trust in the Response he receives from the supposedly authentic site he accessed.

In order to encourage consumer participation in authenticating products, the method can also preferably be combined with remunerative options, such as the chance to win a prize.

Although the above described embodiment is based on a remote, secure response server, a stand-alone response server can also be utilized if the necessary security requirements are deployed. One preferred example is use of a system that uses the function F to generate the secret sets, and a PC or Set-top Box with a Secure SmartCard incorporating the Secret and capable of generating the response without connection to the Remote Server

According to further preferred embodiments, use can be made for the identity tag of materials, such as the base paper or the ink, that, after exposure to the atmospheric oxygen, or to some other chemical trigger, become unreadable after a predefined period of time, such as 24 hours. This prevents the use of ‘old but unused’ secret sets on fake products.

The system can easily be enhanced to enable multiple authentications per product. This is done by associating multiple Secret Sets with the product.

The scratch-off ink printing described hereinabove is a widely known technique. It is applied to a wide range of purposes: lottery tickets, game cards, scratch-off cards, magazine inserts, raffle postcards, and promotional novelties. The scratch-off ink printing process generally involves offset printing the overall design, including the concealed part, applying varnish, and then applying silver ink by screen-printing over the area to be concealed. This print method is not generally available for food products because of the ink residue generated when the surface is scratched off. For this reason, a new printing technique has been developed known as ‘adhesive tape peeling,’ in which gravure-printed adhesive tape is used to peel off the surface ink layer. A special ink that is applicable through screen-printing to produce adhesive tapes is available as TT164SS Silver from the Toyo Ink Company of Addison, Ill., USA, allowing flexibility in smaller lot processing. The DNP America Corporation of New York, N.Y., USA has also developed a new ink that produces a residue-free scratch. As this ink contains material that is harder than a coin, the coin edge is scraped while scratching and its particles stick to the ink-printed part to show the hidden design. This is the equivalent of the penciling (Decomatte) print method that uses coins instead of pencils.

Reference is now made to FIG. 5, which illustrates schematically a tag 20 used for the execution of product authentication, constructed and operative according to a further preferred embodiment of the present invention, using a cellular phone handset. The tag is intended to be attached to products whose authentication is desired. Each tag contains a unique key. The tag 20 comprises an antenna 21, which is tuned for reception of cellular phone transmission and is connected to capacitor 22 which is charged with power received by the antenna 21. The tag comprises a microprocessor 23 having a power input 24, and a short range cellular communication module 25 for transmitting data to and from a cellular phone in the vicinity, by means of Bluetooth, WiMax, WiFi or a similar system. The communication unit 25 is powered through power input 26. Both of the power inputs, 24 and 26 receive their inputs from the capacitor 22, which is charged from cellular reception antenna 21.

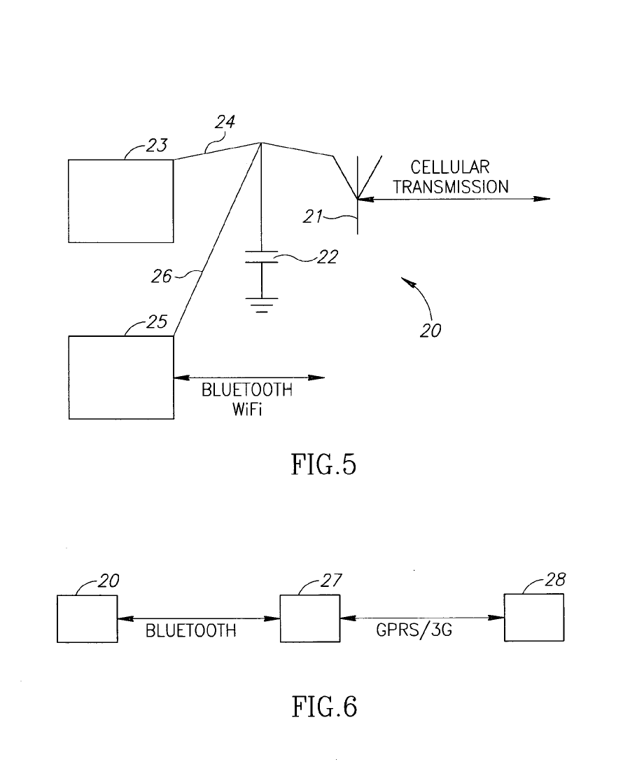

Reference is now made to FIG. 6, which illustrates schematically a preferred embodiment of a method by means of which the tag communicates with the external authentication system. The tag 20 which receives the cellular transmission shown in FIG. 5, is connected via a short-range communication standard such as Bluetooth, to a cellular handset 27, which is itself connected preferably through 3 g/GPRS to the internet and server 28.

In order to operate the system, special software is loaded into the cellular handset of users wishing to use the authentication system. When the user wishes to authenticate a tagged product, the authentication application in the handset is activated. The activation of the authentication application causes the cellular handset to go into a transmission mode. This can be to an imaginary number, or to a real number, but the effect of the transmission is that the antenna 21 in the tag receives the cellular signal and thus charges the capacitor 22. Charging of the capacitor also occurs whenever the cellular handset is active, and not only when the authentication application is running. The antenna 22 is tuned to receive signals at the cellular transmission range. The capacitor is connected to the power input 24 of the microprocessor 23 and to the power input 26 of the communication device 25. To optimize the charging effect, it may be advantageous if the user holds the cellular phone close to the product to be verified.

Once powered, the tag microprocessor 23 wakes up and sends the authentication information from the tag key through the short range communication link to the cellular handset 27. Bluetooth is currently a preferred short range communication system, but it can also be RFID, Near Field Compensation (NFC), WiFi, Wibree, Infra-red (IR), or any other form of communication. The authentication process is then commenced, such as by one of the methods described hereinabove. The authentication can be done either locally at the cellular phone handset 27, or remotely, by the server 28.

In the case of local authentication, the system may preferably be based on a Zero Knowledge Algorithm such as the Fiat-Shamir scheme, as described on pages 9-10 of the article by G. I. Simari entitled “A Primer on Zero Knowledge Protocols”, published by Universidad Nacional del Sur, Argentina. The phone 27 then acts as the Verifier and the Tag 20 as the Prover. Both devices need to have pseudo-random-bits generators. According to this embodiment, the phone will not need to carry any specific secrets, but it will need to carry a list of revoked devices.

In the simpler case of remote authentication, the Prover in the tag 20 sends its certificate to the Server 28, initially to the cellular phone handset 22 by the short range communication link, and then from the cellular phone handset 22 to the server 28 by long range communication, such as GPRS or 3G. From the transmitted certificate, the Server knows the Tag's secret, so it can return to it a random challenge that is encrypted under the Tag's secret. The authentic Tag will decrypt the challenge and send it back to the Server as proof of its identity, while the bogus tag will not be able to do so.

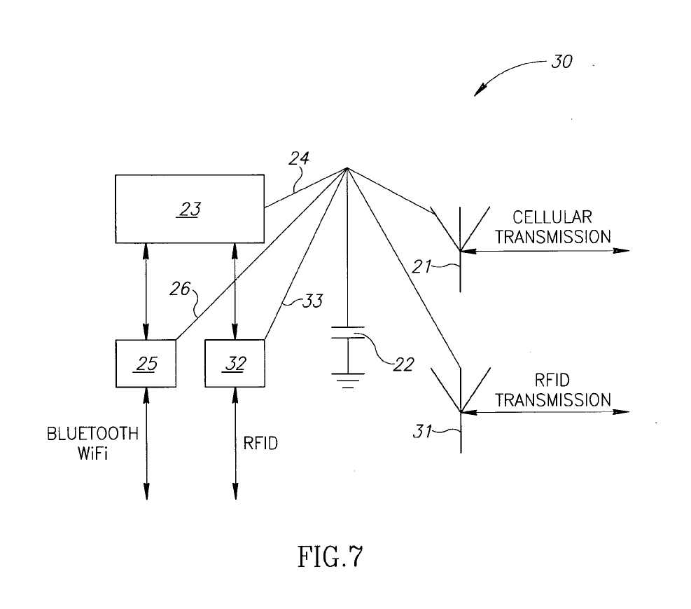

Reference is now made to FIG. 7, which illustrates schematically a further preferred embodiment of the present invention, in which the tag 30 is a dual mode tag, which serves both as an electronic tag and as a cellular communication tag. As in the tag of the embodiment of FIG. 5, the tag includes an antenna 21 tuned for reception of cellular phone transmission, and a short range cellular communication module 25 for transmitting data to and from the cellular phone by means of Bluetooth, WiFi or a similar system. In addition, the tag of FIG. 7 also includes an RFID antenna 31 tuned for RFID signals which charge the capacitor 22 when present, and an RFID communication module 32, powered by an input 33 from the capacitor 22. The RFID communication module 32 enables connection of the microprocessor 23 with the external world by means of an RFID link, as shown. In use, the microprocessor is programmed to check if it has received a valid RFID communication, in which case it serves as an RFID device, or if it has received a Bluetooth signal, in which case it serves as a Bluetooth device, as described in FIGS. 5 and 6 hereinabove.

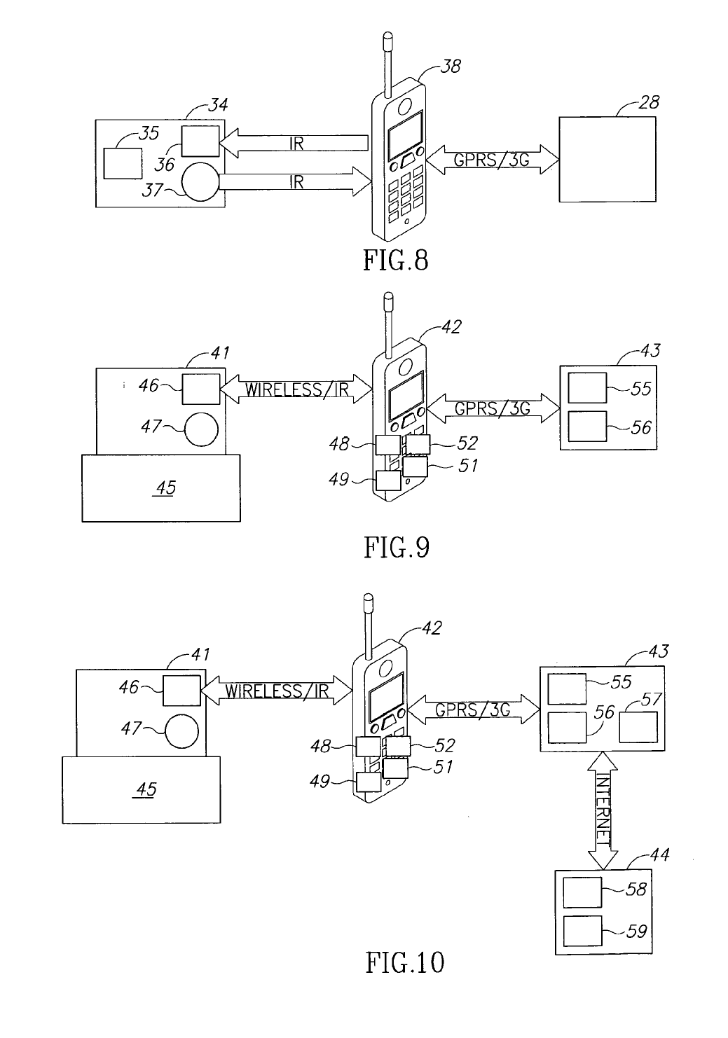

According to a further preferred embodiment of the present invention, as shown in FIG. 8, the tag 34 communicates with the cellular phone using infrared (IR) signals. The tag then needs to be an active device and to contain a battery 35. The tag includes a photoelectric detector 36, which converts the received light signals to electrical signals which wake up the processing elements, and an emitting element, such as a LED 37, for transmission back to the phone 38. According to yet further preferred embodiments, the communication can be established by image processing, whereby the camera in the phone images and deciphers information on the package or the product itself.

According to a further preferred embodiment of the present invention, the cellular transmission signal can be utilized to provide power for any other element associated with the phone, such as an earphone, which can thus be powered to communicate with the phone by means of a short communication standard, such as Bluetooth. This arrangement thus saves the need to provide separate power for the external device communication link.

Reference is now made to FIG. 9, which illustrates schematically a tracking/verification system constructed and operative according to a further preferred embodiment of the present invention. The system comprises three component sub-systems—the product tag 41, a cellular telephone 42 operating as the tag reader, and the decryption server 43.

The product tag 41 is associated with the product 45, and also preferably includes a wireless communication device 46 for linking with the cellular phone 42, such as an RFID link, an IR link, Bluetooth, or any other short range communication method, and optionally also an encryption system 47.

Communication with the product tag 41 is accomplished using communication device 48, which is in contact with the wireless communication device 46 of the tag 41. The phone 42 may also preferably include a decryption application 49 for secure communication with the encryption system 47 of the tag 41. The phone may also include a notification application 51. A communication device 52 such as GPRS or 3G is preferably used for communicating with the authentication server 43.

The authentication server 43 preferably includes a wireless communication device 55 of any suitable type for communicating with the cellular phone, a decryption application 56 and a product data base for responding to the request coming from the cellular phone.

According to a preferred embodiment, the system may operate in the following manner. The user activates the cellular phone transmission by dialing to the number providing access to the verification/tracking service and begins communication with the authentication server 43, which thus now expects to receive a request from the phone 42. The phone also communicates with the product tag 41, such as by means of Bluetooth, and requests the tag's identification (ID), preferably in an encrypted message. The tag will be powered and able to respond either because of the operation of the cellular phone in the vicinity of the tag, as per the previous embodiment of this invention, or simply because of the presence of a Bluetooth transmission. The tag then sends its preferably encrypted ID back to the phone, whose application is programmed to forward it on to the authentication server 43. This server then responds, according to a preferred mode of operation, by checking whether the product ID appears on the list of genuine products in its database, and if so, sending its approval back to the phone. According to another preferred mode of operation, based on the first preferred embodiment of the present invention, as described hereinabove, the server responds by sending a challenge back to the phone, which forwards it to the tag. The tag responds in any predetermined manner that ensures that the response to the challenge is genuine. According to one preferred embodiment, the tag includes a logic program, which can generate the appropriate response to the specific challenge sent, according to preprogrammed criteria. The tag then sends its response back to the phone, which forwards it to the authentication server for decryption and verification. If the response is verified, the server then reports back to the phone, and hence the user, that the product is authentic.

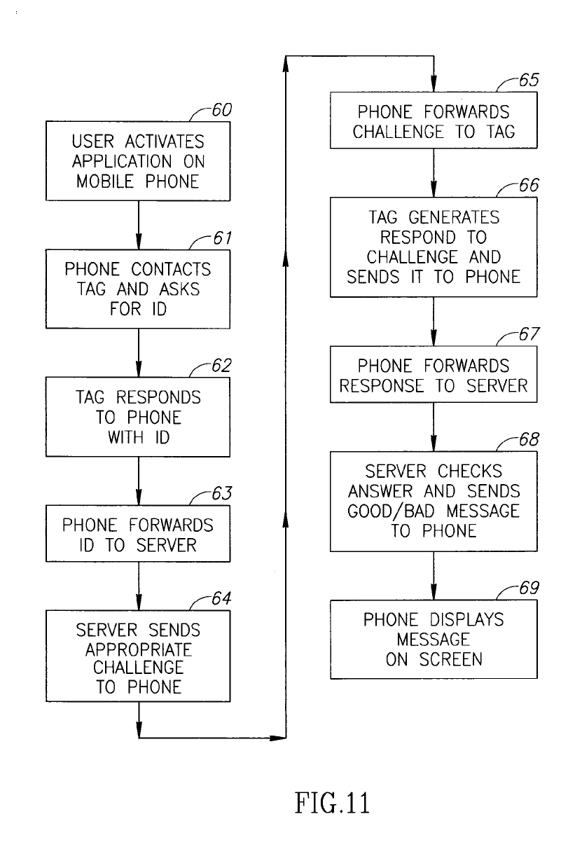

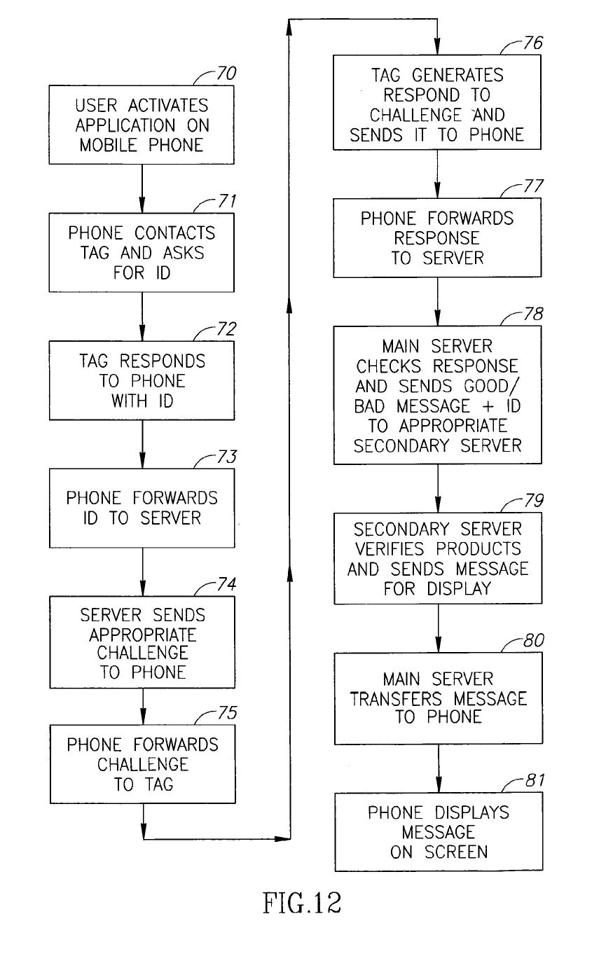

According to other preferred embodiments, the system can operate without the need for the tag to send an ID, but simply by means of a challenge sent from the server. In this embodiment, the phone initially sends its request straight to the server, without the need first to interrogate the tag. In such a case, when the tag receives the challenge from the server via the phone, it adds its own ID to the response, so that once its response is verified, the server knows which product to authenticate, based on the ID which it received from the tag. These preferred methods of operation are described more briefly in flow chart diagrams in FIGS. 11, 12 and 13 below.

Reference is now made to FIG. 10, which illustrates schematically a tracking/verification system constructed and operative according to a further preferred embodiment of the present invention. This embodiment is similar to that shown in FIG. 9, with the exception that by the use of secondary vendor databases for storing product information on secondary servers, the manufacturer's database of products is better protected. This system preferably comprises four component sub-systems—the product tag 41, the tag reader 42, the authentication server 43 and the satellite servers 44 (only one is shown in FIG. 10), which may preferably be configured as vendor servers, each holding part of the complete product database.

As with the system of FIG. 9, the product tag 41 is associated with the product 45, and includes a wireless communication device 46 such as an RFID link, an IR link, Bluetooth, or any other short range method, and optionally also an encryption system 47.

The tag reader terminal 42 can preferably be either a dedicated tag reader such as a piece of store equipment, or a cash register, or a user cellular phone handset. Communication with the product tag 41 is accomplished using communication device 48, which is in contact with the wireless communication device 46 of the tag 41. The terminal may also preferably include a decryption application 49 for secure communication with the encryption system 47 of the tag 41. The reader may also include a notification application 51 and a communication device 52 such as GPRS or 3G for communicating with the server 43.

The decryption Server 43 preferably includes a wireless communication device 55 of any suitable type for communicating with the tag reader terminal 42, a decryption application 56 and a communication system 57 to the vendor data base, which is located on server 44.

Vendor server 44 preferably includes a communication device 58 to the decryption server 43, this communication preferably being accomplished over the internet system, and the vendor data base 59.

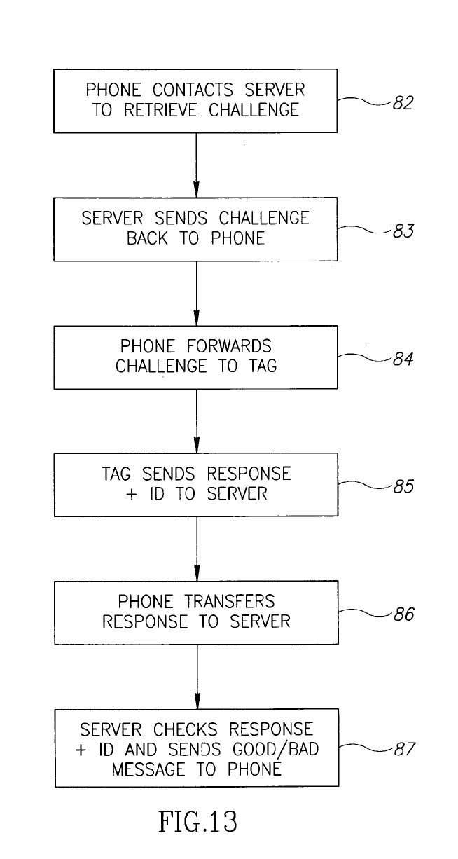

Reference is now made to FIGS. 11 to 13, which are schematic flow charts of the methods described above of performing the verification process. FIG. 11 relates to the system of FIG. 9, FIG. 12 to that of FIG. 10, and FIG. 13 is a simplified method of using the system of FIG. 9. In FIGS. 11 and 13, the verification process proceeds from the product tag 41 to the decryption server 43 via the terminal 42. In these procedures, the verification process is initiated by the end user through the terminal tag reader 42, which may preferably be a cellular phone or store tag-reading equipment. At the end of the verification sequence, either the decryption server 43 or the cell phone/tag reader 42 will have a verified product ID or a verification failure. In case of a failure, the user will be notified by a message on the cellular phone or tag reader. If the verification process has succeeded, for the 4-stage embodiment of FIG. 10, the server detects the vendor, based on the vendor identity contained in the main server database. The product ID is then sent to the appropriate vendor server 44, which returns the information it wants to display on the cell phone or tag reader 42. This response can be programmed to be either identification and validity of the product, which is one object of the enquiry, or any other product information which it is desired to transfer to the enquirer, or a product offer or advertisement. According to further preferred embodiments, such additional product information could include such details as the expiry date of the item, if relevant; the nutritional value, if a foodstuff; a warning if tobacco or alcohol; and dosage or precautions if a medication. Additionally, besides a simple verification message, the enquirer can be provided with further instructions relating to authenticity, such as to inspect the packaging for expiry date, or for a special code relating to verification, etc. Furthermore, information relating to the vendor itself could be included in the response, such as a refusal to authenticate any product held by a vendor or a distributor whose credit status is deficient.

Referring now to the details of FIG. 11, in step 60, the user activates the authentication application on his phone. In step 61, an enquiry is sent from the cellular phone to the tag to retrieve the ID of the product. In step 62, the tag returns to the phone the product ID. In step 63, the phone then transfers the ID to the decryption server, which, based on the ID, in step 64 returns a crypto challenge to the phone, which then applies it back to the product tag in step 65. The tag responds to the challenge in step 66, with a response, which is forwarded to the decryption server in step 67. If the product is authentic, the response is verified as correct by the server in step 68, and the verification result is sent in step 69 directly back to the phone, for displaying the appropriate message on the screen.

Reference is now made to FIG. 12, which is applicable for the system of FIG. 10, which includes the use of vendor servers. Steps 70 to 77 are essentially identical to steps 60 to 67 of the method of FIG. 11. At step 78, the main server checks the authenticity of the response, and if authentic, sends the ID to the appropriate secondary server, preferably with a message as to the status of the authentication. The secondary server, in step 79, then verifies the product's details on its database, and sends a confirmation message back to the main server, which in step 80, returns the message to the phone, for display in step 81 on the phone's screen, this completing the authentication process.

Reference is now made to FIG. 13, which is an alternative simpler procedure for performing the verification process from the product tag, for the embodiment of FIG. 9. In step 82, the phone begins by contacting the server to retrieve a challenge. The server returns the challenge to the phone in step 83, from where it is directed to the tag in step 84. In step 85, the tag provides a response including its encrypted ID. The phone, in step 86 forwards this response to the decryption server, where, if the response is found to be correct for the challenge, the decrypted ID is verified as valid 87, and the verification result is send directly back to the phone for display on the phone's screen. For the embodiment of FIG. 10, using secondary servers, the correct vendor server would be questioned for verification details of the specific product.

According to yet another preferred embodiment of the present invention, there is a further method of performing the verification process, but this method is performed by the cell phone itself, without need of an intermediary server.

There is a pubic modulus N [1024 bits] which is a result of multiplication of 2 secret prime numbers P & Q.

From the ID (typically 5 bytes), a value V [1024 bits] is computed, which is a result of hash function like MD5 operating on ID: V=Hash (ID).

The system than computes S such that S*S mod N=V
a) The Cell Phone asks for an ID from the Tag and computes V
b) The Tag picks a random number R [1024 bits] and send to the phone Y=R̂2 mod N
c) The phone picks 0 or 1 and sends it to the tag
d1) If the phone sends 0—the Tag sends back R[1024 bits], and the phone checks if indeed R̂2=Y
d2) If the phone sends 1—the tag sends back Z=R*S mod N[1024 bits], and the phone checks if indeed Ẑ2 mod N=Y*V mod

According to further preferred embodiments of the present invention, product information may be contained electronically in the tag and sent to the cell phone, which can than display it.

It is appreciated by persons skilled in the art that the present invention is not limited by what has been particularly shown and described hereinabove. Rather the scope of the present invention includes subcombinations and combinations of various features described hereinabove as well as variations and modifications thereto which would occur to a person of skill in the art upon reading the above description and which are not in the prior art. It is also to be understood that the phraseology and terminology employed herein are for the purpose of describing the invention, and should not be regarded as limiting the invention.

What is claimed is:

1. A system for enabling short range communication between an electronic device and a cellular phone operating on a first communication channel, the system comprising:
an antenna on the device adapted to receive cellular transmission from the cellular phone over the first communication channel; and
a second channel for enabling short range communication between the electronic device and the cellular phone;
wherein initiation of cellular transmission over the first communication channel enables the electronic device to be powered by receiving the transmission over the first communication channel through the antenna.

2. A system according to claim 1, and wherein communication between the cellular phone and the electronic device is executed using a communication application activated by use of the phone.

3. A method comprising:
activating a cellular phone transmission and a communication link between the cellular phone and an authentication server;
powering a tag having identity information, by means of the cellular transmission;
communicating with the tag utilizing the cellular phone;
receiving the tag identity information on the cellular phone; and
forwarding the tag identity information from the cellular phone to the authentication server for authentication.

4. The method of claim 3, wherein the step of receiving the tag identity information utilizes an encrypted message.

5. The method of claim 3, wherein the server comprises a database of tag identity information, the method further comprising the step of checking whether the tag identity information appears on the database.

6. The method of claim 3, wherein the authentication comprises the steps of sending a challenge from the server to the tag, receiving the tag's response at the server, and verifying the response on the server.

7. The method of claim 6, further comprising the step of reporting the authentication result to the cellular phone.

8. The method of claim 3, wherein the step of activating the cellular phone transmission comprises dialing a verification service number.
